(19) United States
(12) Patent Application Publication
(10) Pub. No.: US 2012/0185357 A1
(43) Pub. Date: Jul. 19, 2012

(54) Centralized Database Supported Electronic Catalog and Order System for Merchandise Distribution

(76) Inventor: Dan Zhu, Sammamish, WA (US)

(21) Appl. No.: 13/407,407

(22) Filed: Feb. 28, 2012

Related U.S. Application Data
(63) Continuation of application No. 12/383,339, filed on Mar. 23, 2009.
(60) Provisional application No. 61/147,952, filed on Jan. 28, 2009.

(51) Int. Cl. G06Q 30/00

(52) U.S. Cl. 705/26.61

(57) ABSTRACT

A system that permits a retailer to have an in-store computer terminal that is connected to the Internet and configured to access a set of pages on a supplier's server. The accessible pages show a set of merchandise items selected by the retailer and tagged with prices set by the retailer. The terminal is either made available for direct ordering by a retail customer, or ordering by store personnel at the request of a retail customer. Changes in wholesale price or models offered may cause an automatic updating of the display pages, to avoid suboptimal pricing, inaccurate display and orders of unavailable items.

### RELATED APPLICATIONS

This is a continuation of application Ser. No. 12/383,339, filed on Mar. 23, 2009, which claims priority from provisional application filing No. 61/147,952, filed Jan. 28, 2009, which is incorporated by reference as if fully set forth herein.

### BACKGROUND OF THE INVENTION

The present invention relates to a system and method for merchandise distribution from a supplier (such as a wholesaler, distributor or manufacturer) through a local retailer to consumers.

Merchandise distribution from a supplier to consumers may involve any one of several different pathways, each of which has some disadvantages. The major pathways include:
A traditional merchandise distribution process, in which a “brick and mortar” retailer maintains its own retail database separate from the supplier's wholesale database and sells merchandise by displaying merchandise items/samples in kind or on print to in-store shoppers, and selling these items from its in-store stock. It is costly to get the merchandise items or samples on the shelf. It is also a labor intensive process to prepare, distribute and update printed merchandise catalogs or flyers. The multi-step purchase processes are error prone, too. In addition, “brick and mortar” stores are limited in the number of items they can offer customers, by floor space.
In current eCommerce models, transactions are made through a communications network such as the Internet and mobile net, and suppliers may distribute merchandise items by selling directly to consumers or offering their products through third party websites. In either case the online retailer may face an ultra-competitive environment in which third-party price comparison engines drive margins down to a razor-thin level. The consumer is faced with a cacophony of choices that is difficult to evaluate, and confronted with enterprises he is unfamiliar with and may find difficult to evaluate, in terms of trustworthiness and permanence.

Currently, many retail locations have a system that enables them to order items that are not in stock, for customers. The retailer may have catalogs from supply warehouses that a store clerk can order from, for a customer who wishes to purchase an item that is not in stock. This system is somewhat problematic, as the set of catalogs must be kept current, and it may not be immediately apparent which catalog to reference, to find a desired item. Also, the amount of clerical work associated with generating an order may be so great as to disrupt retail operations.

One option that some stores implement is a computerized electronic catalog system for ordering items that are not stocked or are out of stock. This may have the advantage that some of the paperwork associated with generating an order is eliminated. There is still, however, the issue of the labor needed to set up an electronic catalog and the problem of keeping up with changes in supplier-offered products.

If, for example, a supplier stops producing the A-7000 model widget, replacing it with the A-8000 model, the change may not be entered into the retailer's computerized order generating system. Consequently, a customer who orders the A-7000, may later find that the A-8000 has been delivered to him. He may not like the fact that he has not received exactly what he ordered. In another scenario, the price of the A-7000 has been raised, but this information has not been entered into the retailers computerized order generating system. The retailer has accepted payment of an amount predicated on the old wholesale price, but is later billed by the supplier at the new wholesale price, either reducing or in the worst case, completely eliminating the retailer's profit.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The preferred embodiments permit a retailer to have an in-store computer terminal that is connected to the Internet and configured to access a set of pages on a supplier's server. The accessible pages show a set of merchandise items selected by the retailer and tagged with prices set by the retailer. The terminal is either made available for direct ordering by a retail customer, or ordering by store personnel at the request of a retail customer. Changes in wholesale price or models offered may cause an automatic updating of the display pages, to avoid suboptimal pricing and orders of unavailable items.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced drawings. It is intended that the embodiments and figures disclosed herein are to be considered illustrative rather than restrictive.

FIG. 1 is a block diagram of the retail system preferred embodiment of the present invention.

FIG. 2 is a diagram illustrating a web page displayed by the wholesale dataset of the system of FIG. 1.

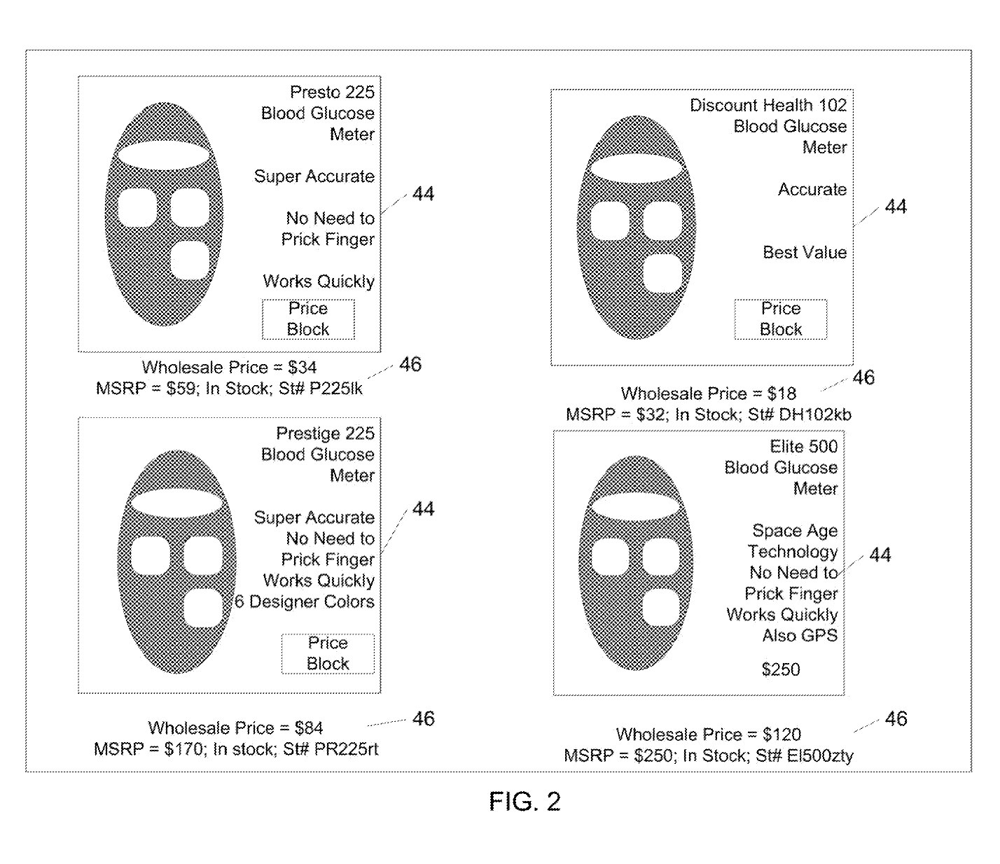

FIG. 3A is a diagram illustrating a web page displayed on the store M electronic catalog 13 of FIG. 1, which reflects choices made by a store manager and stored in the directory-of-stores database 18.

FIG. 3B is a diagram illustrating the web page of FIG. 3A, after search results have been returned.

FIG. 3C is a diagram illustrating the web page of FIG. 3A, after further information regarding the search results has been requested by a user.

FIG. 4 is a block diagram showing the datasets and dataset entries that affect or are affected by the shopper experience in the system of FIG. 1.

FIG. 5 is a flowchart illustrating the purchase process that may be implemented on the system of FIG. 1.

### DETAILED DESCRIPTION OF THE PREFERRED EMBODIMENT

### Definitions

1. Supplier: A wholesaler, distributor or manufacturer that sells merchandises though retailers to consumers.
2. Local Retailer: A business selling merchandises to consumers with transaction done at a local brick and mortar retail store with physical building for operation. An authorized local retailer is authorized to access the supplier's database for information about its merchandises, convert the supplier's website to the retailer's as electronic catalog and order system to show to shoppers and sell the merchandises to the shoppers.
3. Store Manager: A representative who is authorized to represent a local retailer to set up a retailer account with the supplier, configure an electronic catalog and order system for the store, and purchase merchandises from the supplier.
4. In-store Shopper: A consumer selecting and purchasing merchandises at a local retail store.
5. Cashier: A retail store employee who collects payment and approves orders placed by in-store shoppers.

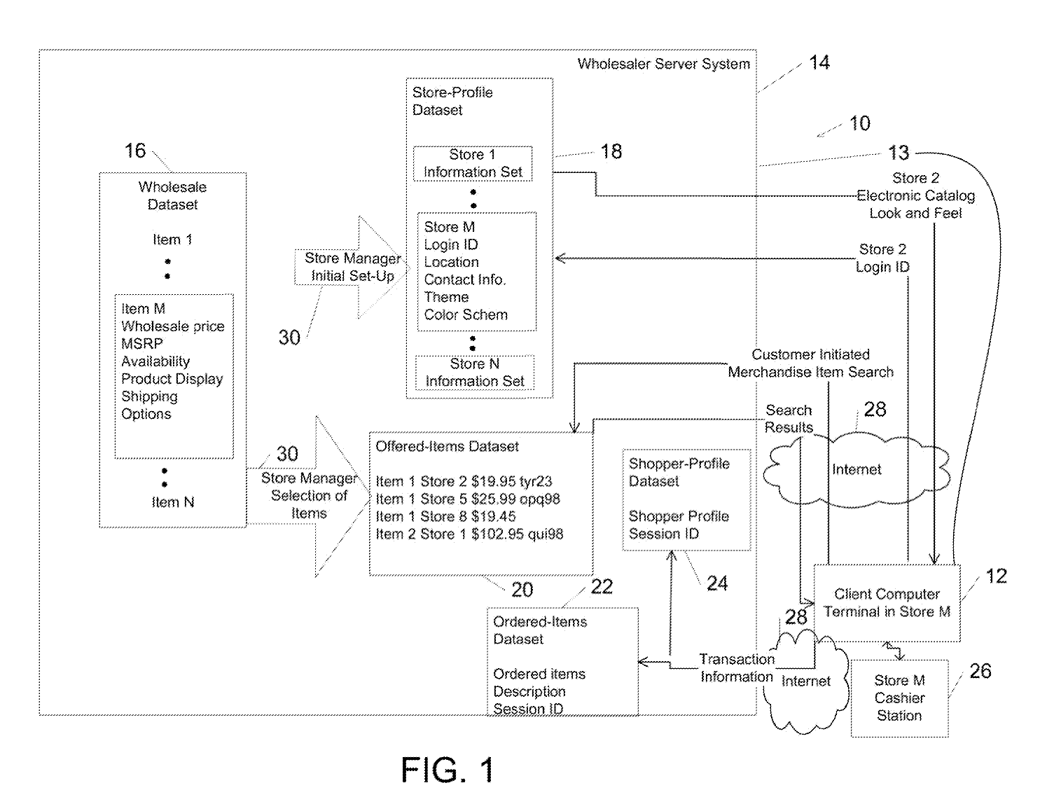

Referring to FIG. 1, in a preferred embodiment the present invention takes the form of a system 10, adapted to facilitate a store, having a computer terminal 12 connected to the Internet 28, in configuring and maintaining an electronic catalog 13, formed by terminal 12 logging into and cooperatively engaging with a wholesaler server system 14. Much of the system consists of software hosted on the wholesaler server system 14, which could include many servers. In the following text a “store M” is any one of N different stores that have a terminal 12 that forms a part of system 10.

The following datasets may be easily constructed using SQL or Oracle® DBMS. They may be thought of as each being a table with each line or row of the table representing a subset of data that is all inter-related on some logical basis.

The wholesaler server system 14 hosts:
1) A wholesale dataset 16 storing a row of information for each item offered by the wholesaler. This information includes an item identifying code, wholesale price, manufacturers suggested retail price (MSRP), availability, and a product display typically including a photograph of the product and details of the products functionality and shipping options. Other information regarding the item may also be included;
2) A store-profile dataset 18 (“store dataset” in provisional application), detailing information, such as address and other contact information, about each store participating in the system 10, and sales tax rate, login information for the store manager to configure the in-store electronic catalog/order system and for cashiers to access and process shopper orders. Dataset 18 also includes “look and feel” information for each store's electronic catalog 13, such as color scheme, font choice, logo and text to appear on all pages or a listed subset of pages; The store-profile dataset 18 also includes a general pricing rule that will be discussed later and payment terms agreed between the supplier and local retailer.
3) An offered-items dataset 20 (“retail dataset” in provisional application) having a row (subset) of entries for each instance of any retail item being offered by any store's electronic catalog 13 (an “item-store pair”). For each item-store pair, a retail price is listed and a store item number may be listed;
4) An ordered-items dataset 22 (“order detail dataset” in provisional application) listing each item selected for purchase by in-store shopper using system 10 and for each transaction noting the session identifier, which is automatically assigned when a previously dormant terminal 12 becomes active, the store ID of the store M at which transaction was made, item #, quantity ordered, price, the shopper order reference number, which is automatically assigned when a shopper accesses the checkout feature, and subtotal. The ordered-items dataset may also include a pricing rule for the individual item that will be discussed later;
5) A shopper-profile dataset 24 (“shopper dataset” in provisional application) listing shopper information for each session that has reached the “checkout” stage. As noted in the previous paragraph, when checkout is reached a shopper order reference number is assigned and information entered by the shopper, including contact information (email address and phone number) and shipping information (delivery address) is recorded. Dataset 24 also includes entries for shopper payment due and shopper payment time and store order reference number, which will be discussed further below.

For each store M, a computer terminal 12 that is connected to the Internet 28 (either directly or over a cell or mobile net connection) is configured to be automatically logged into the store-profile dataset 18, where it's basic formatting is stored. In one preferred embodiment, store M has many terminals 12, configured in this manner. Moreover, store M could be a chain of stores, each having one or more computers logged into the same entry in store-profile dataset 18.

To begin the process of setting up an electronic catalog 13, a store manager 30 logs into the wholesale server system 14. A graphical user interface (GUI) prompts the store manager 30 to enter various pieces of identifying information, for example a logon and password. Store information, such as store address and phone number, may also be requested. This information is stored in the store M entry in the store-profile dataset 18. Various fraud prevention techniques may be implemented, for example verifying store information through third party sources, to avoid being victimized by fraud artists.

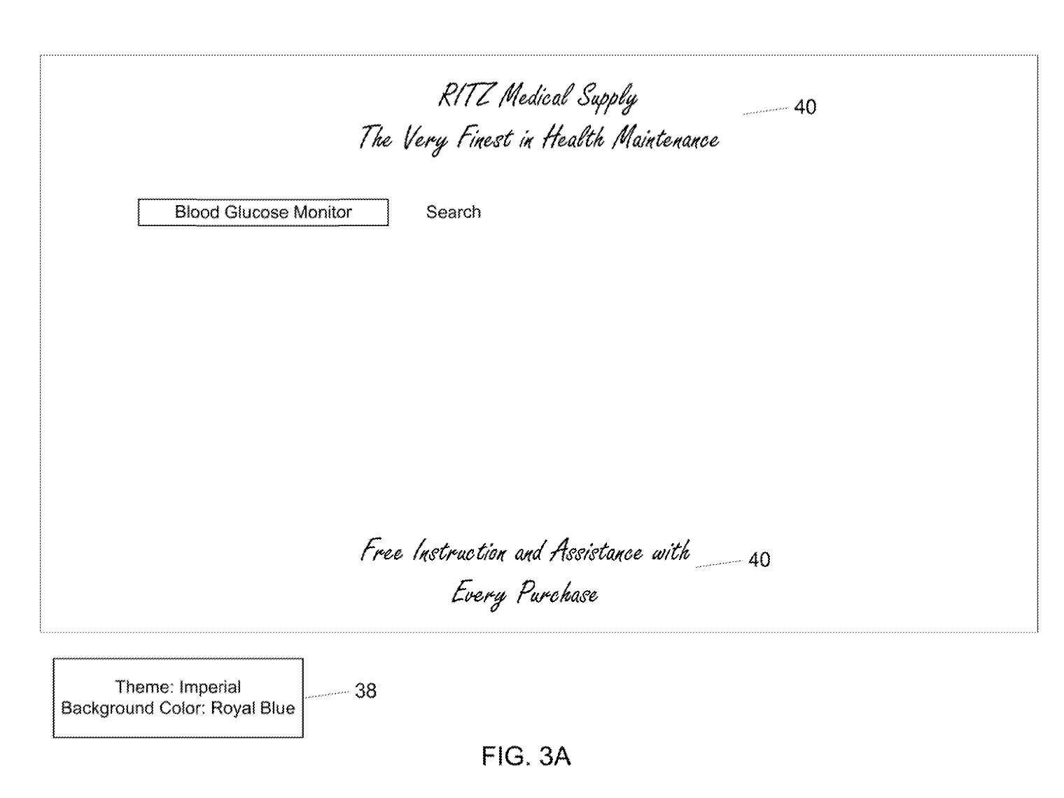

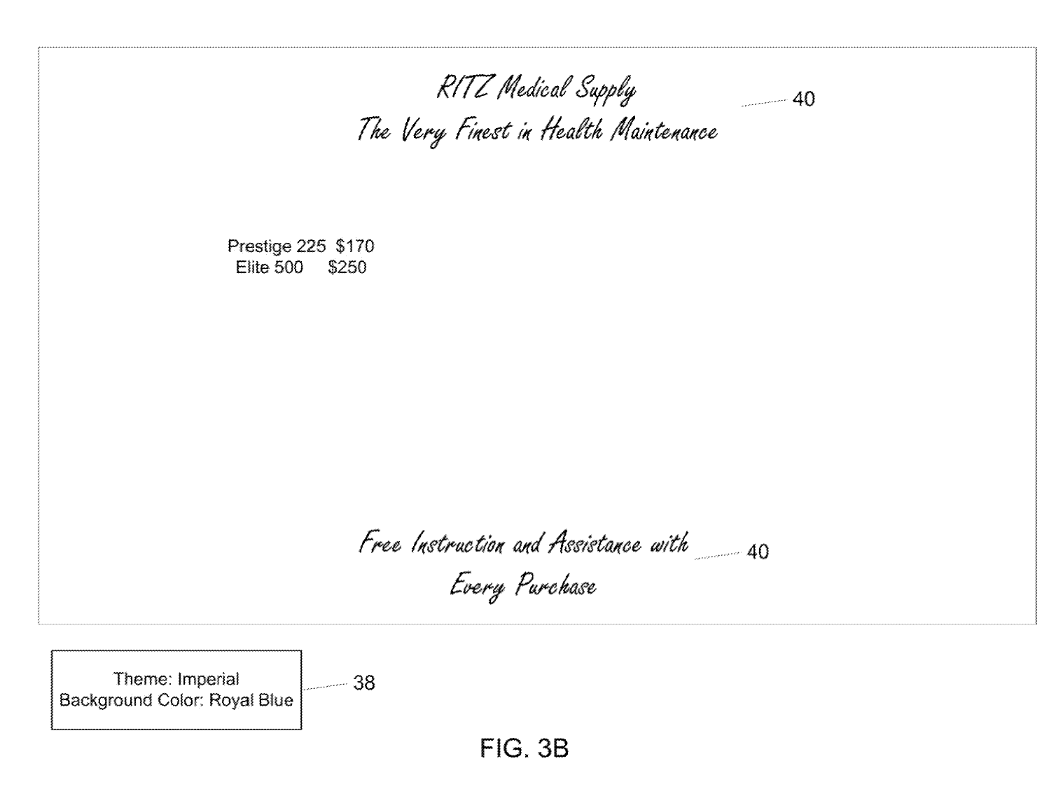

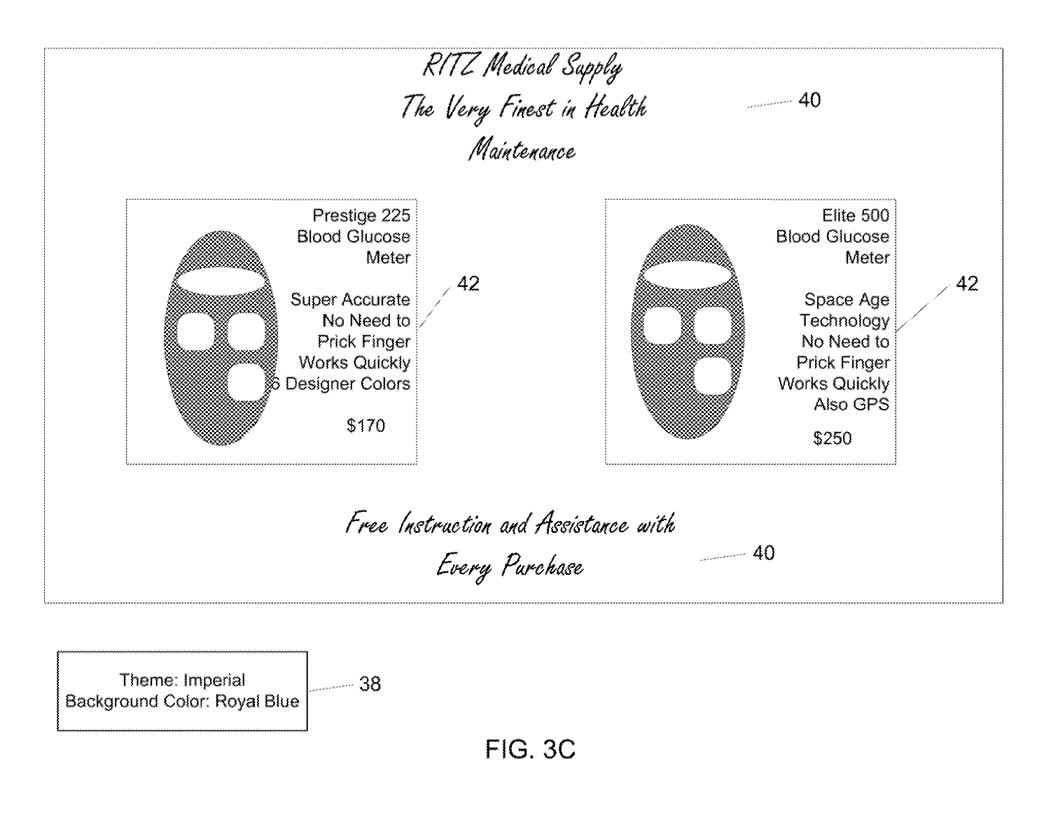

After the store manager has entered adequate preliminary data, he is prompted to choose a theme and color scheme 38 (FIGS. 3A-3C) and to upload images (such as a logo) and choose text and font 40 (FIGS. 3A-3C) to appear on each web page of the electronic catalog 12 for store M. The store manager is also prompted to enter a general pricing rule. Such a rule could be a percentage added to the wholesale price, or subtracted from the manufacturers suggested retail price. Other types of pricing rules are possible. In one preferred embodiment it is possible to enter different general pricing rules for differing classes of merchandise. All of this information is entered into the store M entry line (data subset) in the store-profile dataset.

To further configure the electronic catalog 13, a store manager 30 for store M logs into the wholesaler server system 14 and makes a set of item choices that are reflected in the offered-items dataset 20. For each item, the system 14 initially fills in the price based on the general pricing rule. The store manager 30 may override this choice with an individual pricing rule. Individual pricing rules are stored in the offered-items dataset 20 in the data line for the item-store pair for which the individual pricing rule applies. In one preferred embodiment the store manager 30 also selects a page and position for each item selected for store M (item-store pair), in the offered-items dataset 20. This information is stored in further informational positions in the table line (data subset) for the item-store pair in the offered-items dataset 20.

FIG. 3B shows a page of the electronic catalog 13 showing “glucose monitor” search results for a high-end pharmaceutical retailer, for which the store M manager 30 has made a choice to not carry the less expensive items. The store M manager 30 by making a series of choices has configured an electronic catalog 13 that has a high-end look and feel. FIG. 3C shows a page of the electronic catalog 13 showing product displays from wholesale dataset 16 for the two glucose monitors listed in the search results of FIG. 3B. A user may request to view the product displays by, for example, clicking on the search result items in which he has an initial interest. (The connection between dataset 16 and terminal 12 is not shown in FIG. 1 for ease of presentation).

In a preferred embodiment offered-items entries listed in the offered-items dataset 20 are automatically updated when changes occur to the wholesale dataset 16. These changes are typically either price changes or product changes. A price change may be a change to either the wholesale price or the MSRP or (most typically) both. Depending on the pricing rule, each retail price is automatically updated to reflect the new wholesale price or MSRP. This automatic update provision saves store personnel from clerical drudgery. Moreover, it avoids the instance of a retail price not being updated after a change in a wholesale price. This sort of error can cost a store money, if a lower price, that does not reflect a higher wholesale price, is charged.

In addition, many companies occasionally replace an old product model with a new product model. When this happens, the product description associated with the item # in the wholesale dataset are updated, thereby automatically changing the information seen by the shopper when he requests the product description. In some instances the update will create a new entry for the new model but leave the entry for the old model, at a discount, until the inventory of old models is sold out, at which point the “old model” entries are eliminated from dataset 16 and the new model is associated with the old item #. This avoids a troublesome common error for retailers, that of inadvertently offering a model that is, in fact, no longer available. In a situation like this many wholesalers will simply ship the updated model. This may cause the customer to telephone the retailer demanding to know why a different product has been received. Also, the retailer may have to pay a higher wholesale price for the new model, thereby reducing or eliminating profit on the sale. Accordingly, the new model-automatic update feature avoids consumer confusion and protects the store's profits. This also avoids inaccurate descriptions of merchandises in catalogs that are separately prepared by retailers, and any resulting disputes.

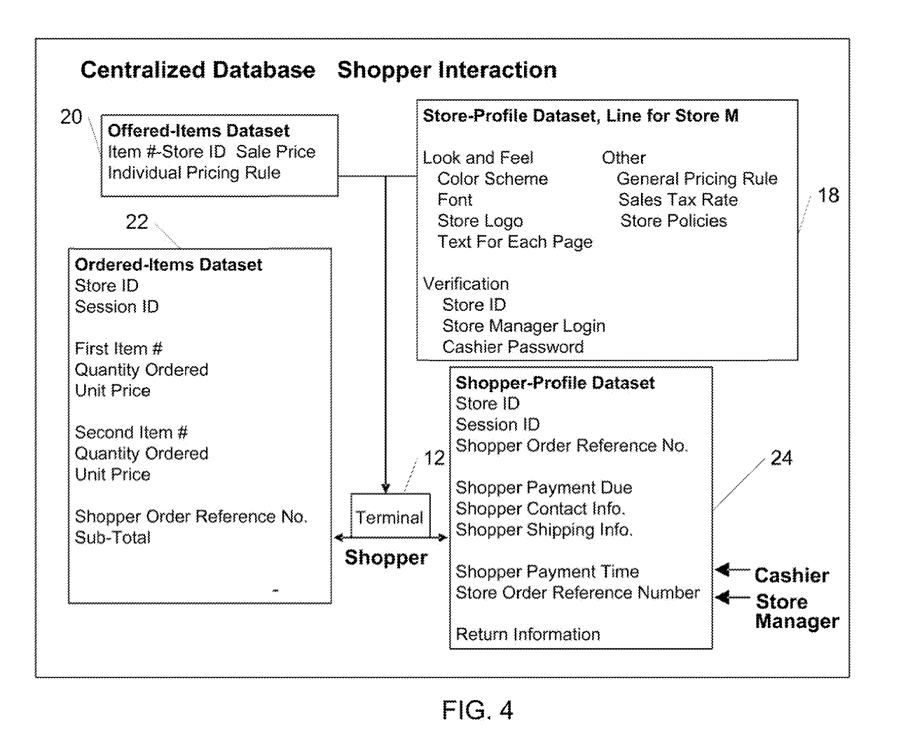

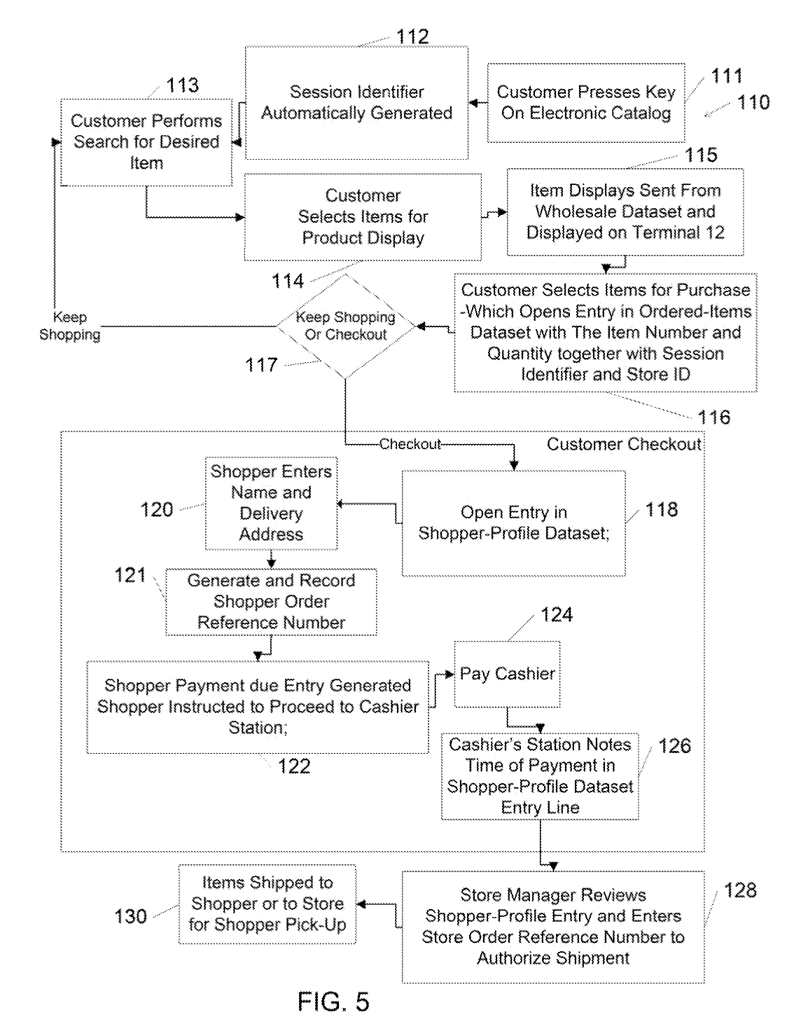

Referring to FIGS. 4 and 5, the purchase process 110 begins with a shopper in store M, who accesses electronic catalog 13 (block 111) thereby causing a new session to be noted by the system 10 and a session identifier to be automatically issued and associated with the new session (block 112). The user performs a search or browses through the online catalog for a product type of interest (block 113) and selects items for which he would like to see a product display (block 114). The product displays, descriptions and availabilities are sent from wholesale dataset 16 (for ease of presentation the communicative path between dataset 16 and terminal 12 is not shown in the figures) to terminal 12 (block 115) and the shopper picks one of more items for purchase, which opens entry in ordered-items dataset with the item number and quantity together with the session identifier and store ID (block 116). The shopper then either chooses checkout or continue shopping (block 117), to perform a search or browse through the catalog 13 for a different product category.

The choice of “checkout” opens an entry in the shopper-profile dataset 24 (block 118). The shopper is then prompted to enter his name and delivery address (block 120). When this information has been entered, a shopper order reference number is automatically generated and recorded in both the ordered-items dataset 22 and shopper-profile dataset 24 (block 121). Also, a shopper payment due entry is generated and recorded in the shopper-profile dataset and the shopper is then directed to move (block 122) to the cashier station 26 to pay for the merchandise (124).

In one preferred embodiment, the cashier station is directly electronically connected to system 10, and when payment is received, the entry in the shopper-profile dataset 24 is automatically updated or manually updated by a cashier (such as by entering payment receiving time) to reflect payment (block 126). The store manager 30 must approve the shopper-profile order entry (block 128), by assigning store order reference numbers, thereby assuming responsibility for payment to the wholesaler, or make payment to wholesaler using one of traditional or electronic payment methods, in order for shipment to occur, to the address entered by the shopper, or to the store for shopper pick-up (block 130). The store manager 30 may assign a different store order reference number to each individual session identifier, or may assign a store order reference number to a group of session identifiers. Each store order reference number is stored in the shopper-profile dataset 24.

The ordered-items dataset 22 is updated with each shopper session so that it includes a session identifier, shopper order reference number, items ordered, price charged for each item and store ID. The shopper-profile dataset 24, is updated with each session to include shopper payment due (when payment has not yet been made), shopper contact information, shopper shipment information, the session identifier, store ID; shopper order reference number, shopper payment time and store order reference number. In case of merchandise return, the dataset is also filled with return data, reasons of the return and refund amount. The store M entries in the ordered-items dataset 22 and the shopper-profile list dataset 24 are made available to the store M manager. Skilled persons will recognize the values of these lists for understanding the business of store M, and exploiting trends as well as generating mailing lists.

The ordered-items dataset 22 and shopper-profile dataset 24 are protected by a hierarchical password system, so that a cashier is assigned a password that permits viewing of purchases made but not yet paid for, whereas the store manager 30 is provided with a higher level password that permits more extensive access, for purchase from wholesaler and shipping approval, analysis of commercial trends and generation of customer contact programs.

There are many different ways for the store M client computer 12 to be configured so that it automatically logs into the store M entry in directory of store-profile dataset 18, over the Internet. In a first method, the store M ID is stored as a cookie on client computer 12. The store M client computer is configured to enter the general address of the wholesaler server system into a browser address bar, and then to enter the store ID into a dialogue box that appears as a result. In another, the store M dataset has its own web address, formed by using a sub-domain such as http://StoreID.SupplierDomainName or by using a subfolder such as http://SupplierDomainName/StoreID/. In either case the client computer 12 is configured to automatically open a browser having the web address of the store M dataset in its address bar, upon startup. In one preferred embodiment the store M client computer is locked to the store M entry in dataset 18 and can only be unlocked by entry of a special unlocking code, so that store customers do not use the terminal 12 for other purposes.

As noted earlier, the dataset structures described in reference to FIG. 1 may be constructed using a relational database management system such as SQL or Oracle® DBMS. Software adapted to create a display using information from dataset 18 for the look and feel of the electronic catalog 13 and from dataset 20 for a listing of search results may reside on each terminal 12, or may reside on server system 14.

The preferred embodiments described above yield a number of advantages to both wholesalers and retailers. From the retailer's perspective, it is possible to construct an electronic catalog 13 by using content from the wholesale dataset 16, without the work of generating product displays, and yet achieving a desired website look and feel. The retailer is also freed from the task of keeping a sharp eye on notices from wholesalers about model changes and price changes, as the offered-items dataset 20 is automatically updated by the wholesale dataset. This may permit retailers to find an optimum balance between keeping product in stock or relying on the stock at the wholesaler's warehouse for order fulfillment. It may be possible for some retailers to stock only demo models, with all orders being fulfilled from the electronic catalog 13. In one preferred embodiment, the store M electronic catalog 13 is made available to online customers. Although some wholesalers may view this as direct competition to their own online merchandizing, it may permit them to make sales to those customers who are familiar with a particular “brick and mortar” store, while permitting the “brick and mortar” store to offer their customers another purchase option.

From the wholesaler's perspective, the preferred embodiments offer release from the ultra-competitive world of online sales, where third-party price comparison engines can drive margins down to virtually nothing. By easing the commercial tasks facing the “brick and mortar” competition, the preferred embodiments offer a system where the wholesaler and retailer are both rewarded with higher sales, and can both get a slice of the sales margin. The preferred embodiments also save the time and cost for the wholesaler to introduce products into local retail stores, streamline the multi-stage processes of merchandise distribution, and minimize the chance of disputes on product displays, descriptions and pricings due to any updates on the wholesaler side.

Even if the preferred embodiments offered advantages to both wholesalers and retailers, however, it would not be truly advantageous, unless it also offered advantages to consumers. The preferred embodiments permit a consumer to access a much wider range of merchandise from the “brick and mortar” store than he would otherwise be able to do, while avoiding the cacophony of Internet product searching, where a confusing welter of online merchants may appear. The consumer may, moreover, be reassured by the physical presence of the store personnel and feel that if something goes wrong with the purchase he has a known physical location to ask for assistance or to return the product. Moreover, if the store does stock a demo model for the item the consumer is considering purchasing, he is then able to inspect the item more thoroughly then would be typically possible online.

The same techniques described above for creating a store M data set can also be used to assemble a flyer or paid advertisement. In a preferred embodiment, product displays may be downloaded from wholesale dataset 16. An individual pricing rule may be entered item/store pair entry in dataset 20 at the same time a merchandise item is chosen for the flyer, in order to create a special offer.

In one preferred embodiment a website is made available to consumers to comment on items purchased. These comments are then made available to be included in the product displays of the electronic catalog 13.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. An electronic catalog system comprising:
(a) a first dataset having a set of product listings, each including product information and a wholesale price of said product;
(b) a second dataset listing for each one of a set electronic catalogs, a subset of said set of product listings being offered for sale, each electronic catalog being associated with a separate store, said second dataset also listing a retail price for each listing of a product in each subset; and
(c) wherein any one of a set of changes in said first dataset causes an automatic change in said second dataset.

2. The system of claim 1 wherein a change to the wholesale price for one of said products automatically causes a change in a said retail price corresponding to a said listing of said product in a said subset.

3. The system of claim 2 wherein a change to the wholesale price for one of said products automatically causes a change in a plurality of said retail prices corresponding to listings of said products in a plurality of said subsets.

4. The system of claim 1 wherein at least some of said retail prices listed in said second dataset are based on a general pricing rule that is based on said wholesale price.

5. The system of claim 1 wherein said wholesale dataset also lists a manufacturer's suggested retail price for each item.

6. The system of claim 5 wherein at least some of said retail prices are based on a general pricing rule based on said manufacturer's suggested retail price.

7. The system of claim 6 wherein a change in said manufacturer's suggested retail price for a product automatically results in changes to said retail prices that are based on a general pricing rule based on said manufacturer's suggested retail price.
